(19) United States
(12) Patent Application Publication
(10) Pub. No.: US 2019/0370437 A1
(43) Pub. Date: Dec. 5, 2019

(54) OPTIMIZING SERVER LICENSING COSTS

(71) Applicant: VMware, Inc., Palo Alto, CA (US)

(72) Inventors: Chandrashekhar Jha, Bangalore (IN); Vishal Gupta, Bangalore (IN); Kumar Gaurav, Bangalore (IN); Amit Kumar, Bangalore (IN); Nibunan G. S., Bangalore (IN)

(73) Assignee: VMware, Inc.

(21) Appl. No.: 16/000,441

(22) Filed: Jun. 5, 2018

(51) Int. Cl. G06F 21/10; G06F 9/455

(52) U.S. Cl. CPC G06F 21/105; G06F 3/04842; G06F 9/45533

(57) ABSTRACT

Examples described herein include systems and methods for optimizing licensing costs for a server. In one example, at least two licenses (a first license and a second license) are available for the server. The first license can cost more than the second license but allow for a greater number of VMs to run on the server. The example method can include determining whether the server is running the first license and the number of VMs running on the server. If the server is using the first license but the number of VMs running on the server is less than or equal to the number potentially allowed by the second license, an action can be taken for changing the server's license subscription. For example, the method can include displaying a GUI element or sending a message that indicates the cost savings associated with changing the licenses.

### BACKGROUND

Enterprises commonly utilize servers to support enterprise-level management, data storage, applications, and communications. Servers can be necessary to support Mobile Device Management (“MDM”) and Enterprise Mobility Management (“EMM”) systems (collectively, “EMM systems”). In order to provide certain functionality, a server can make use of an operating system (“OS”), such as WINDOWS SERVER or LINUX. The enterprise typically must purchase a license for the OS in order to utilize the OS on the server.

Various types of licenses are available for any given server. The license types can differ based on the OS that is supported as well as the scope of the license. For example, licenses can cover a particular number of physical hardware sockets at the server or physical processors run by the server. Licenses can allow a certain number of virtual machines (“VMs”) to execute on the server, with each VM running an instance of the licensed OS. Some licenses allow for a combination of sockets and VMs per server. For servers that execute a large number of VMs, licenses can be purchased for supporting numerous, or even unlimited, VMs on a particular server.

Typically, an administrator purchases licenses for the enterprise's servers. The administrator can choose appropriate licenses based on the servers' current or expected workload. However, the servers' workloads can change over time. In a system with many servers, the license costs can be overlooked as server loads fluctuate. For example, an administrator can initially purchase a “datacenter” level license for a server, allowing for unlimited VMs to execute on the server. Over time, the use of the server can fall to a level that would only require an “enterprise” level license supporting, for example, two VMs to be run on the server. Continued use of the more expensive server license would cost the enterprise money by missing out on potential cost savings.

Administrators lack the tools to effectively identify potential cost savings connected to server licenses. The task of manually reviewing licenses, server utilization, and potential cost savings across multiple servers is simply too onerous for administrators to tackle. At best, an administrator might review the license costs on a yearly basis or when the licenses otherwise are set to renew or expire. Enterprises therefore continue to lose money by paying for unnecessary server licenses.

As a result, a need exists for systems and methods for optimizing server licensing costs and assisting administrators in identifying potential cost savings.

### SUMMARY

Examples described herein include systems and methods for optimizing licensing costs for a server. An example method includes determining whether a first license applies to a server. The first license can allow for a greater number of VMs to run on the server relative to a second license. The first license can also cost more than the second license.

The example method can also include determining a number of VMs running on the server. This number can be a maximum number of VMs running at once over a period of time, in an example. The method can also include determining a number of VMs that are potentially allowed to run on the server, based on the second (cheaper) license.

The method can further include, if the first license applies to the server and the number of VMs running on the server is less than or equal to the number of VMs potentially allowed to run on the server based on using the second license, performing an action for changing a license subscription for the server from the first license to the second license.

In one example, performing an action for changing the license subscription comprises displaying a graphical user interface (“GUI”) element on a computing device. The GUI element can indicate that changing the license subscription for the server from the first license to the second license would reduce costs. For example, the GUI element can include an estimated cost savings from changing the license subscription.

Performing an action for changing the license subscription can also include generating a message to an administrator, where the message informs the administrator that changing the license subscription for the server from the first license to the second license would reduce costs. In some examples, performing an action for changing the license subscription comprises executing a script that implements the second license at the server while minimizing user intervention.

The stages of the example method can be performed in response to a user selecting a GUI element displayed on a computing device, such as a button that initiates an optimization process. In some examples, the stages of the example method can be performed automatically. For example, the stages can be performed based on a predetermined time period, such as on a weekly or monthly basis.

The examples summarized above can each be incorporated into a non-transitory, computer-readable medium having instructions that, when executed by a processor associated with a computing device, cause the processor to perform the stages described. Additionally, the example methods summarized above can each be implemented in a system including, for example, a memory storage and a computing device having a processor that executes instructions to carry out the stages described.

Both the foregoing general description and the following detailed description are exemplary and explanatory only and are not restrictive of the examples, as claimed.

### BRIEF DESCRIPTION OF THE DRAWINGS

FIG. 1 is a flowchart of an exemplary method for optimizing licensing costs for a server.

FIG. 2 is a flowchart of an exemplary method for optimizing licensing costs for a server.

FIG. 3 is system diagram of an example system for optimizing licensing costs for a server.

FIG. 4 is an illustration of an example user interface for optimizing licensing costs for a server.

### DESCRIPTION OF THE EXAMPLES

Reference will now be made in detail to the present examples, including examples illustrated in the accompanying drawings. Wherever possible, the same reference' numbers will be used throughout the drawings to refer to the same or like parts.

Examples described herein include systems and methods for optimizing licensing costs for a server. In one example, at least two licenses (a first license and a second license) are available for the server. The first license can cost more than the second license but allow for a greater number of VMs to run on the server relative to the number allowed by the second license. The example method can include determining whether the server is running the first, more expensive license, as well as determining the number of VMs running on the server. If the server is using the first license but the number of VMs running on the server is less than or equal to the number potentially allowed by the second license, then the example method can include performing an action for changing a license subscription for the server from the first license to the second license. For example, the method can include displaying a GUI element or sending a message that indicates the cost savings associated with changing the licenses. It can also include executing a script that implements the second license without user intervention.

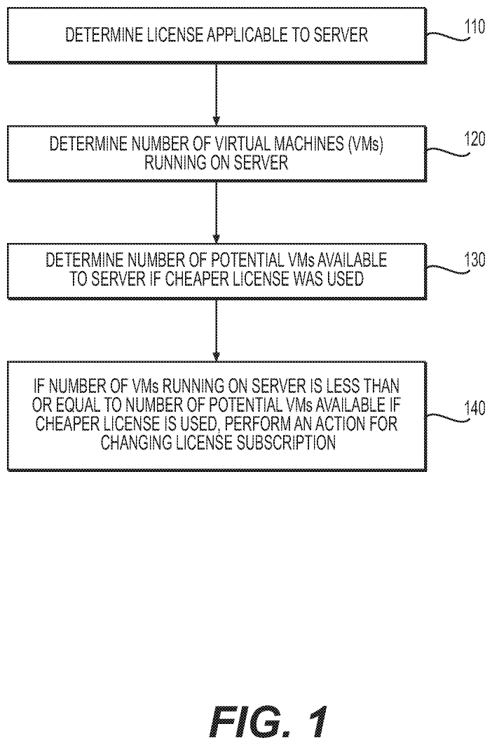

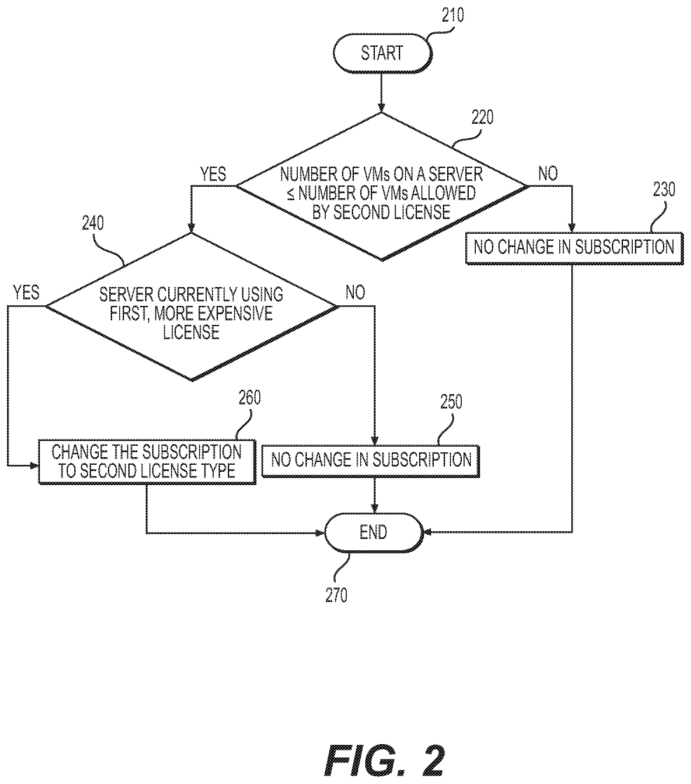

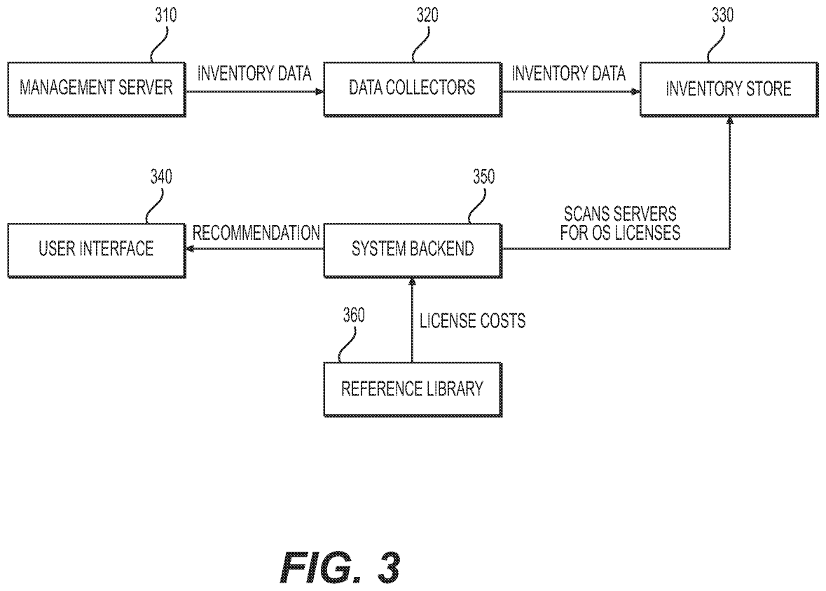

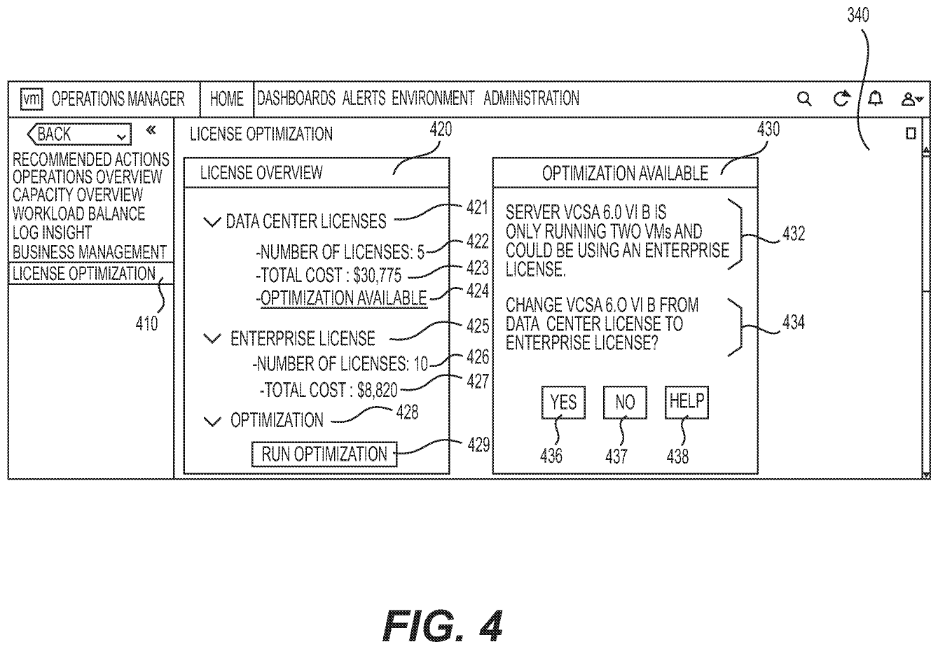

FIGS. 1 and 2 provide flowcharts of example methods for optimizing licensing costs for a server. FIG. 3 provides an illustration of an example system for optimizing licensing costs for a server. FIG. 4 provides an illustration of an example user interface for optimizing licensing costs for a server.

Turning to the example method of FIG. 1, stage 110 can include determining the type of license applicable to a server. The license type for a server in a data center can be stored in an inventory store, which can be a database in an example. This can indicate a first license that already applies to the server, allowing the system to determine that the first license applies to the server. The first license can cover some or all of the VMs that operate on the server. For example, each VM can run an OS that is authorized under the first license.

As described in more detail with respect to FIG. 3, the inventory store can be populated with inventory data regarding the data center. For example, one or more data collectors can be used to collect data from a management server or other centralized platform for managing a data center. The collected data can include various information regarding the servers in the data center, including the number of servers, the current and historical loads on each server, hardware and software specifications for each server, the number of VMs running on each server, the type of OS license applicable to each server, and the hierarchical structure of servers, clusters, VMs, and any other relevant system components. The collected data can be stored in an inventory store.

Stage 110 can include accessing the inventory store to obtain information regarding the type of OS license used by a particular server. The data can be obtained by a backend service of a management platform. An example backend service can be provided by VMWARE's vRealize Business for Cloud product, a cloud management platform that provides tools for managing a cloud system. The backend service can access the inventory store and pull data regarding the type of OS license used by a server at stage 110.

The backend service can also access information regarding the number of VMs currently running on a server. This information can be contained in the data obtained by the backend service at stage 110. The data can indicate, for example, a license type in use and a number of VMs being run at the server. At stage 120, the backend service can parse the data to determine a number of VMs running on the server.

At stage 130, the backend service can determine a number of potential VMs available to the server if a different, cheaper license was used in place of the current license. A server can use various OS types and various licenses associated with each OS type. One example server OS is WINDOWS SERVER. Various license types are currently available for that OS. Looking at three examples, MICROSOFT offers (1) Standard, which allows one virtual instance (VM) per license, (2) Enterprise, which allows four VMs per license, and (3) Datacenter, which allows unlimited VMs per license. The license costs vary based on their scope. In one example, the Standard license can have a first cost per individual license, with a minimum of five licenses required; the Enterprise license can have a second cost (lower than the first cost) per individual license, with a minimum of 25 licenses required; and the Datacenter license can have a third cost per processor.

The example above applies to just a subset of license types available for one server OS. Of course, various server OS types are available, including WINDOWS SERVER 2012 and RED HAT ENTERPRISE LINUX. The pricing structure and license scope can vary with each server OS type. Furthermore, the pricing structure and license scopes can change from year to year. Calculating server costs is therefore not a straightforward task.

Up-to-date information regarding available licenses and their associated cost and scope can be stored in a reference library. At stage 130, the backend service can obtain data from the reference library reflecting available licenses and their associated costs and scopes. As an example, the backend service can obtain data indicating that a second license is available for the server. The second license can be cheaper than the first license currently running on the server and can allow for fewer VMs to be run on the server.

At stage 140, the backend service can compare the usage of the server to the scope of the available licenses. In particular, the backend service can compare the number of VMs running on the server to the number of VMs potentially allowed by the second, cheaper license. If the number of VMs running on the server is less than or equal to the number of VMs potentially allowed by the second license, the backend service can perform an action for changing the license subscription. As explained in more detail with respect to FIG. 4, taking an action can encompass a variety of actions, such as displaying an informational message or alert on a user interface or performing some or all of the steps required to cancel the first license and implement the second license at the server.

FIG. 2 provides a flow diagram illustrating the decision-making process that can be performed by the system. The process can begin at stage 210 as part of an automated system routine or as an operation launched by an administrator. At stage 220, the system considers whether the number of VMs on a server is less than or equal to the number of VMs allowed by a second license. The number can be a maximum number of VMs that were contemporaneously active during past time period, such as in the past 12 hours or past day. Alternatively, the number can be a real-time number of VMs on the server. If the number of VMs on the server is greater than the number of allowed VMs, then at stage 230 the system can determine that no change in subscription to the second license is necessary.

In some examples, stage 220 can be performed for more than one license. In one example, the server at issue runs eight VMs and operates under a first license that allows unlimited VMs. A second license allows ten VMs while a third license allows five VMs. Stage 220 can include comparing the number of VMs on the server (eight) to the number of VMs allowed by a third license (five) and determine that no change to the third license is required because the third license does not provide for a sufficient number of VMs. Stage 220 can be repeated by considering the second license, which in this example includes comparing the number of VMs on the server (eight) to the number of VMs allowed by the second license (ten). Because the number of VMs on the server is less than the number allowed by the second license, the process can continue to stage 240 based on the second license (but not the third). In some examples, the comparison at stage 220 is performed starting with the cheapest license option available for the server. When the result of stage 220 is a “yes,” the process can then continue at stage 240.

Stage 240 can include determining whether the server is currently using a more expensive license than the second license examined at stage 220. This can include obtaining data regarding the current license type being used by the server and obtaining cost information for that license type as well as the second license. If the server is not using a more expensive license—for example, because the server is already using the second license—then at stage 250 the process can result in no change in the license subscription. If, on the other hand, the server is using a license that is more expensive than the second license, the method can proceed to stage 260.

Stage 260 can include performing an action regarding changing the subscription to the second license type. As explained in more detail with respect to FIG. 4, taking an action can encompass a variety of actions, such as displaying an informational message or alert on a user interface or performing some or all of the steps required to cancel the first license and implement the second license at the server. The process can end at stage 270.

FIG. 3 provides an illustration of an example system for carrying out the various methods described herein. The system can include a management server 310 that can provide centralized control over a data center. The management server 310 can be a single server or a network of servers. It can utilize one or more processors and memory stores. The management server 310 can provide an administrator with tools to visualize and manage a data center infrastructure. For example, the management server 310 can run one or more VMWARE solutions, such as vSphere Client, vCenter Server, and vRealize Suite.

The management server 310 can store various types of information associated with a data center. For example, it can store information regarding the physical servers in the data center, including their names and locations, physical hardware, supported clusters, current and historical loads, installed software, the number of VMs running on each server, OS type, OS license type, other physical or virtual components in the data center, and the hierarchical structure of all of the components within the data center.

The system can also include data collectors 320 capable of collecting data stored at the management server 310 or in a database accessible by the management server 310. The data collectors 320 can include one or more software instances executing on one or more servers within the data center. In some examples, a physical server running one or more VMs can include a data collector 320, such as a performance manager, executing as a software component on the server. The data collector 320 can receive real-time instance data from the VMs executing on the server. The data collector 320 can also receive information at predetermined time intervals. Regardless of the form of the data, the data collector 320 can transmit this data to a client application or “roll up” the data spanning a particular time period and store the rolled-up data in an inventory store 330.

The inventory store 330 can be a standalone database in one example. In another example, the inventory store 330 is a partition or portion of a server, such as the management server 310. The data collectors 320 can have read, write, and edit access to the inventory store 330 in order to store data collected from the data center servers.

An administrator can access a user interface 340 associated with the system. In some examples, multiple user interfaces are available to an administrator. The user interface 340 of the system of FIG. 3 can be associated with software that provides optimization and analysis tools such as cloud cost tracking, current and planned workload cost comparison, and consumption tracking and analysis across business groups, applications, and services. An example software product associated with the user interface 340 is VMWARE's vRealize Business for Cloud, although any other suitable software can be used. An examiner user interface 340 is provided in FIG. 4.

The system of FIG. 3 can also include a system backend 350. The system backend 350 can include the backend of the system providing the user interface 340 described above. For example, the system backend 350 can include at least a portion of a software product providing data center management tools, optimization and analysis tools, workload cost comparison, consumption tracking and analysis, and any other relevant features. The backend 350 is depicted as a standalone element in the system of FIG. 3 at least for the purpose of illustrating the sources of data that are considered in making a recommendation or taking an action at the user interface 340.

The system of FIG. 3 can also include a reference library 360. The reference library 360 can be a standalone database, a portion of a database, or a memory storage location within a server, the inventory 330, or the management server 310. The reference library 360 can store information regarding available licenses. For example, it can store one or more tables that list the available licenses. The table can include columns for types of information associated with each available license, such as the type of OS associated with the license, the cost of the license, the scope of the license, the number of VMs allowed by the license, whether the license is currently being used (and if so, an identification of the servers using the license), the expiration date of the license, instructions for cancelling or initiating the license, and any other relevant information.

The reference library 360 can track additional information about the different license types. For example, it can include a license ID, a threshold number of VM instances, and a price. The threshold number of VM instances can indicate the number of VMs available at the price. The price can be per VM or a total amount for the threshold number of VMs. In one example, the license type can include a tiered pricing structure based on the number of VMs. In this example, multiple records can indicate the different prices for the various licensing thresholds (threshold numbers of VMs).

The reference library 360 can be accessible by the system backend 350. The system backend 350 can therefore retrieve information about licensing availability and costs from the reference library 360 and retrieve information about the current status and utilization of the data center from the inventory store 330. The system backend 350 can then perform a method, such as the example methods described with respect to FIGS. 1 and 2, to determine whether to take an action with respect to changing the license for one or more servers in the data center.

The system backend 350 can execute an algorithm based on the inventory and license details in the inventory store 330. For example, the number of VMs on the server can be determined based on either a real-time snapshot, a maximum number of VMs during a time period, or an average number of VMs during a time period. The algorithm can use more than one of these numbers of VMs to optimize licensing in an example. The number of VMs can be compared against the licensing thresholds to determine the cheapest combination of licenses. In one example, if at least two of the real-time number, maximum number, and average number of VMs correspond to a different licensing configuration, the system can take action.

Taking an action can include causing the user interface 340 to display information or provide options for an administrator. In some examples, taking an action can include performing at least some of the steps required to cancel a first license and initialize a second license with respect to a server.

FIG. 4 provides an illustration of an example user interface 340 described above. The user interface 340 can be provided by software installed on the management server 310 or a computing device associated with an administrator, or both. In one example, the user interface 340 is provided by VMWARE's vRealize Operations Manager.

The user interface 340 can provide a variety of menu options. In this example, an option 410 for “License Optimization” is selected. The License Optimization option 410 can display information regarding license optimization for an administrator to view and potentially act upon. In the example of FIG. 4, the user interface 340 includes a License Overview box 420. The License Overview box 420 can include expandable menu for displaying license and cost information. In this example, the License Overview box 420 provides an expandable option for data center licenses 421 as well as an expandable option for enterprise licenses 425. These selections are merely exemplary. In some examples, a single expandable option is provided that encompasses all licenses in use by the datacenter. In another example, an expandable option is provided for each distinct license. The illustration of FIG. 4 is not intended to be limiting.

The expandable option for data center licenses 421 can include an indication of the number of that type of license that has been purchased 422, the total cost for those licenses 423, and an indication that optimization is available 424. Similarly, the expandable option for the enterprise licenses 425 can include an indication of the number of that type of license that has been purchased 426 and the total cost for those licenses 427. In this example, no indication for available optimization is provided for the enterprise licenses 425.

The License Overview box 420 can also include a menu option for optimization 428. Expanding that menu option 428 can cause optimization-related tasks to be displayed on the user interface 340. In this example, a button 429 is provided to “Run Optimization.” Selecting this button 429 can cause the system to run an optimization process such as the processes described above with respect to FIGS. 1 and 2. As described above, those processes can result in “taking an action” with respect to changing the license applied to a particular server.

In this context, “taking an action” can include, for example, displaying a notice that optimization is available, such as the indication 424 within the License Overview box 420. Taking an action can also include displaying the Optimization Available box 430 on the user interface 340. The Optimization Available box 430 can include a description 432 that explains the particular optimizations available. In the example of FIG. 4, the description 432 explains that a particular server “is only running two VMs and could be using an Enterprise License.”

“Taking an action” can also include displaying a prompt 434 for taking a suggested action based on the available optimization. In this example, the prompt 434 asks the administrator whether to “Change VCSA 6.0 UI B from Data Center License to Enterprise License?” The prompt 434 can also include information regarding the cost savings associated with this change as well as any other relevant information. The user interface 340 can display buttons 436, 437 for answering the prompt 434 yes or no. It can also include a help 438 button that can cause the user interface 340 to display more detailed information about the identified server, license, or process for changing the license.

If the user selects the yes button 436, the system backend 350 can take additional actions with respect to changing the license. For example, the system backend 350 can provide instructions to the administrator for changing the license status of the identified server. In another example, the system backend 350 executes a script that causes the current license to be cancelled and institutes the optimized license identified in the prompt 434. If the user selects the no button 437, the system can take no further action. In some examples, the user interface 340 can hide the prompt 434, the description 432, the Optimization Available box 430, or some combination thereof.

Other examples of the disclosure will be apparent to those skilled in the art from consideration of the specification and practice of the examples disclosed herein. Though some of the described methods have been presented as a series of steps, it should be appreciated that one or more steps can occur simultaneously, in an overlapping fashion, or in a different order. The order of steps presented are only illustrative of the possibilities and those steps can be executed or performed in any suitable fashion. Moreover, the various features of the examples described here are not mutually exclusive. Rather, any feature of any example described here can be incorporated into any other suitable example. It is intended that the specification and examples be considered as exemplary only, with a true scope and spirit of the disclosure being indicated by the following claims.

What is claimed is:

1. A method for optimizing licensing costs for a server, the stages of the method comprising:
determining whether a first license applies to the server, wherein the first license allows for a greater number of Virtual Machines (VMs) to run on the server relative to a second license and wherein the first license costs more than the second license;
determining a number of VMs running on the server;
determining a number of VMs potentially allowed to run on the server based on using the second license; and
if the first license applies to the server and the number of VMs running on the server is less than or equal to the number of VMs potentially allowed to run on the server based on using the second license, performing an action for changing a license subscription for the server from the first license to the second license.

2. The method of claim 1, wherein performing an action for changing the license subscription comprises displaying a Graphical User Interface (GUI) element on a computing device, the GUI element indicating that changing the license subscription for the server from the first license to the second license would reduce costs.

3. The method of claim 2, wherein the GUI element includes an estimated cost savings from changing the license subscription.

4. The method of claim 2, wherein the stages are performed in response to a user selecting a GUI element displayed on a computing device.

5. The method of claim 1, wherein performing an action for changing the license subscription comprises generating a message to an administrator, the message informing that changing the license subscription for the server from the first license to the second license would reduce costs.

6. The method of claim 1, wherein performing an action for changing the license subscription comprises executing a script that implements the second license at the server without requiring user intervention.

7. The method of claim 1, wherein the stages are performed automatically based on a predetermined time period.

8. A non-transitory, computer-readable medium comprising instructions that, when executed by a processor of a computer device, perform stages for optimizing licensing costs for a server, the stages comprising:
determining whether a first license applies to the server, wherein the first license allows for a greater number of Virtual Machines (VMs) to run on the server relative to a second license and wherein the first license costs more than the second license;
determining a number of VMs running on the server;
determining a number of VMs potentially allowed to run on the server based on using the second license; and
if the first license applies to the server and the number of VMs running on the server is less than or equal to the number of VMs potentially allowed to run on the server based on using the second license, performing an action for changing a license subscription for the server from the first license to the second license.

9. The non-transitory, computer-readable medium of claim 8, wherein performing an action for changing the license subscription comprises displaying a Graphical User Interface (GUI) element on a computing device, the GUI element indicating that changing the license subscription for the server from the first license to the second license would reduce costs.

10. The non-transitory, computer-readable medium of claim 9, wherein the GUI element includes an estimated cost savings from changing the license subscription.

11. The non-transitory, computer-readable medium of claim 9, wherein the stages are performed in response to a user selecting a GUI element displayed on a computing device.

12. The non-transitory, computer-readable medium of claim 8, wherein performing an action for changing the license subscription comprises generating a message to an administrator, the message informing that changing the license subscription for the server from the first license to the second license would reduce costs.

13. The non-transitory, computer-readable medium of claim 8, wherein performing an action for changing the license subscription comprises executing a script that implements the second license at the server without requiring user intervention.

14. The non-transitory, computer-readable medium of claim 8, wherein the stages are performed automatically based on a predetermined time period.

15. A system for optimizing licensing costs for a server, comprising:
a memory storage including a non-transitory, computer-readable medium comprising instructions; and
a computing device including a processor that executes the instructions to carry out stages comprising:
determining whether a first license applies to the server, wherein the first license allows for a greater number of Virtual Machines (VMs) to run on the server relative to a second license and wherein the first license costs more than the second license;
determining a number of VMs running on the server;
determining a number of VMs potentially allowed to run on the server based on using the second license; and
if the first license applies to the server and the number of VMs running on the server is less than or equal to the number of VMs potentially allowed to run on the server based on using the second license, performing an action for changing a license subscription for the server from the first license to the second license.

16. The system of claim 15, wherein performing an action for changing the license subscription comprises displaying a Graphical User Interface (GUI) element on a computing device, the GUI element indicating that changing the license subscription for the server from the first license to the second license would reduce costs.

17. The system of claim 16, wherein the stages are performed in response to a user selecting a GUI element displayed on a computing device.

18. The system of claim 15, wherein performing an action for changing the license subscription comprises generating a message to an administrator, the message informing that changing the license subscription for the server from the first license to the second license would reduce costs.

19. The system of claim 15, wherein performing an action for changing the license subscription comprises executing a script that implements the second license at the server without requiring user intervention.

20. The system of claim 15, wherein the stages are performed automatically based on a predetermined time period.
